(19) United States
(12) Patent Application Publication
(10) Pub. No.: US 2023/0422212 A1
(43) Pub. Date: Dec. 28, 2023

(54) INFORMATION PROCESSING METHOD, DEVICE, AND STORAGE MEDIUM

(71) Applicant: SHENZHEN TRANSSION HOLDINGS CO., LTD., Shenzhen (CN)

(72) Inventor: CHIUN-WEI HUANG, Shenzhen (CN)

(73) Assignee: SHENZHEN TRANSSION HOLDINGS CO., LTD., Shenzhen (CN)

(21) Appl. No.: 18/464,498

(22) Filed: Sep. 11, 2023

Related U.S. Application Data
(63) Continuation of application No. PCT/CN2021/082813, filed on Mar. 24, 2021.

(51) Int. Cl. H04W 68/02; H04L 5/00; H04W 72/1273

(52) U.S. Cl. CPC H04W 68/02; H04L 5/0005; H04W 72/1273

(57) ABSTRACT

Disclosed are an information processing method, an information processing device, and a storage medium. The method includes: receiving a paging indication signal, where the paging indication signal includes at least one indication information, and the indication information is configured to indicate at least one physical downlink share channel (PDSCH) time-frequency resource block that provides a paging message of a terminal group; and receiving the paging message in the corresponding PDSCH time-frequency resource block according to the indication information.

### CROSS-REFERENCE TO RELATED APPLICATIONS

This application is a continuation application of International Application No. PCT/CN2021/082813, and filed on Mar. 24, 2021. The disclosures of the above-mentioned applications are incorporated herein by reference in their entireties.

### TECHNICAL FIELD

Embodiments of the present application relate to communication technologies, and in particular, to an information processing method, an information processing device, and a storage medium.

### BACKGROUND

In 5G new radio (NR), a terminal device can switch between multiple working states, thereby reducing power consumption.

When the terminal device is in the idle state (RRC_IDLE) or inactive state (RRC_INACTIVE), the network device can initiate paging to the terminal device. In some related art, the terminal device can monitor whether there is a paging indication corresponding to the terminal device on a physical downlink control channel (PDCCH). If there is the paging indication corresponding to the terminal device on the PDCCH, a physical downlink share channel (PDSCH) is further decoded to obtain paging message.

However, all terminal devices instructed to decode PDSCH will receive paging message on the same PDSCH time-frequency resource (Control Resource Set, CORESET), which cannot distinguish different service requirements and lacks flexible configuration.

The foregoing description is provided to provide general background information and does not necessarily constitute prior art.

### SUMMARY

The present application provides an information processing method, an information processing device, and a storage medium to solve the problem of lack of flexible configuration for the terminal device to receive paging message.

According to a first aspect, embodiments of the present application provide an information processing method, applied to a terminal device, the method including:
receiving a paging indication signal, where the paging indication signal includes at least one indication information, and the indication information is configured to indicate at least one physical downlink share channel (PDSCH) time-frequency resource block that provides a paging message of a terminal group; and
receiving the paging message in the corresponding PDSCH time-frequency resource block according to the indication information.

In an embodiment, receiving the paging message in the corresponding PDSCH time-frequency resource block according to the indication information includes:
determining a position of the PDSCH time-frequency resource block according to the indication information; and
receiving the paging message through the resource block corresponding to the position.

In an embodiment, the paging indication signal is downlink control information (DCI) or radio resource control (RRC) signaling.

In an embodiment, the terminal group to which it belongs is determined according to a type and/or a state of the terminal device.

In an embodiment, the at least one indication information is configured to instruct at least one terminal group to use at least two PDSCH time-frequency resource blocks.

In an embodiment, the state of the terminal device includes an idle state and/or an inactive state; and/or
the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the position of the PDSCH time-frequency resource block is determined by at least one of the following ways:
determining the position of the PDSCH time-frequency resource block according to the resource configuration information in the frequency domain;
determining the position of the PDSCH time-frequency resource block according to the resource configuration information in the time domain;
determining the position of the PDSCH time-frequency resource block according to the resource offset indication information in the frequency domain;
determining the position of the PDSCH time-frequency resource block according to the resource offset indication information in the time domain;
determining the position of the PDSCH time-frequency resource block according to the index of the resource block.

In an embodiment, the resource offset indication information is configured to indicate a resource offset of any group relative to a reference group.

In an embodiment, the resource configuration information in the frequency domain includes a sequence number of a subcarrier and/or a number of subcarriers.

In an embodiment, the resource configuration information in the time domain includes a sequence number of a symbol and/or a number of symbols.

According to a second aspect, embodiments of the present application provide an information processing method, applied to a network device, the method including:
determining at least one indication information, where the indication information is configured to indicate at least one PDSCH time-frequency resource block that provides a paging message of a terminal group; and
sending paging indication signal, wherein the paging indication signal includes the at least one indication information.

In an embodiment, the method further includes:
determining a position of at least one PDSCH time-frequency resource block for providing paging message of the terminal group; and
generating the indication information according to the position of the PDSCH time-frequency resource block.

In an embodiment, the paging indication signal is downlink control information (DCI) or radio resource control (RRC) signaling.

In an embodiment, the terminal group is determined by a type and/or a state of the terminal device.

In an embodiment, the at least one indication information is configured to instruct at least one terminal group to use at least two PDSCH time-frequency resource blocks.

In an embodiment, the state of the terminal device includes an idle state and/or an inactive state; and/or

the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the indication information is determined by at least one of the following ways:
determining the resource configuration information in the frequency domain according to a position of the PDSCH time-frequency resource block;
determining the resource configuration information in the time domain according to the position of the PDSCH time-frequency resource block;
determining the resource offset indication information in the frequency domain according to the position of the PDSCH time-frequency resource block;
determining the resource offset indication information in the time domain according to the position of the PDSCH time-frequency resource block;
determining the index of the resource block according to the position of the PDSCH time-frequency resource block.

In an embodiment, the resource offset indication information is configured to indicate a resource offset of any group relative to a reference group.

In an embodiment, the resource configuration information in the frequency domain includes a sequence number of a subcarrier and/or a number of subcarriers.

In an embodiment, the resource configuration information in the time domain includes a sequence number of a symbol and/or a number of symbols.

According to a third aspect, embodiments of the present application provide an information processing method, applied to a terminal device, the method including:
obtaining carrier indication information; and
receiving paging message according to the carrier indication information and a paging indication signal, where the paging indication signal includes at least one indication information, and the indication information is configured to indicate at least one PDSCH time-frequency resource block that provides a paging message of a terminal group.

In an embodiment, the carrier indication information includes at least one of the following:
master carrier information;
secondary carrier information;
master cell group information;
secondary cell group information.

In an embodiment, before receiving the paging message according to the carrier indication information and the paging indication signal, the method further includes:
obtaining the paging indication signal.

In an embodiment, receiving the paging message according to the carrier indication information and the paging indication signal includes:
determining a position of the PDSCH time-frequency resource block according to the carrier indication information and the paging indication signal; and
receiving the paging message through the resource block corresponding to the position.

In an embodiment, at least one of the following is included:
the paging indication signal is downlink control information (DCI) or radio resource control (RRC) signaling;
the carrier indication information is RRC signaling;
the terminal group to which it belongs is determined according to a type and/or a state of the terminal device;
the at least one indication information is configured to instruct at least one terminal group to use at least two PDSCH time-frequency resource blocks.

In an embodiment, the state of the terminal device includes an idle state and/or an inactive state; and/or
the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the position of the PDSCH time-frequency resource block is determined by at least one of the following ways:
determining the position of the PDSCH time-frequency resource block according to the resource configuration information in the frequency domain;
determining the position of the PDSCH time-frequency resource block according to the resource configuration information in the time domain;
determining the position of the PDSCH time-frequency resource block according to the resource offset indication information in the frequency domain;
determining the position of the PDSCH time-frequency resource block according to the resource offset indication information in the time domain;
determining the position of the PDSCH time-frequency resource block according to the index of the resource block.

In an embodiment, at least one of the following is included:
the resource offset indication information is configured to indicate a resource offset of any group relative to a reference group;
the resource configuration information in the frequency domain includes a sequence number of a subcarrier and/or a number of subcarriers;
the resource configuration information in the time domain includes a sequence number of a symbol and/or a number of symbols.

According to a fourth aspect, embodiments of the present application provide an information processing method, applied to a network device, the method including:
determining carrier indication information;
sending the carrier indication information and a paging indication signal, where the paging indication signal includes at least one indication information, and the indication information is configured to indicate at least one PDSCH time-frequency resource block that provides a paging message of a terminal group.

In an embodiment, the carrier indication information includes at least one of the following:
master carrier information;
secondary carrier information;
master cell group information;
secondary cell group information.

In an embodiment, the method further includes:
determining a position of at least one PDSCH time-frequency resource block for providing paging message of the terminal group; and
generating the indication information according to the position of the PDSCH time-frequency resource block.

In an embodiment, at least one of the following is included:
the paging indication signal is downlink control information (DCI) or radio resource control (RRC) signaling;
the carrier indication information is RRC signaling;
the terminal group is determined according to a type and/or a state of the terminal device;
the at least one indication information is configured to instruct at least one terminal group to use at least two PDSCH time-frequency resource blocks.

In an embodiment, the state of the terminal device includes an idle state and/or an inactive state; and/or
the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the indication information is determined by at least one of the following ways:
determining the resource configuration information in the frequency domain according to the position of the PDSCH time-frequency resource block;
determining the resource configuration information in the time domain according to the position of the PDSCH time-frequency resource block;
determining the resource offset indication information in the frequency domain according to the position of the PDSCH time-frequency resource block;
determining the resource offset indication information in the time domain according to the position of the PDSCH time-frequency resource block;
determining the index of the resource block according to the position of the PDSCH time-frequency resource block.

In an embodiment, at least one of the following is included:
the resource offset indication information is configured to indicate a resource offset of any group relative to a reference group;
the resource configuration information in the frequency domain includes a sequence number of a subcarrier and/or a number of subcarriers;
the resource configuration information in the time domain includes a sequence number of a symbol and/or a number of symbols.

According to a fifth aspect, embodiments of the present application provide an information processing device, applied to a terminal device, including:
a first receiving module, configured for receiving a paging indication signal, where the paging indication signal includes at least one indication information, and the indication information is configured to indicate at least one physical downlink share channel (PDSCH) time-frequency resource block that provides a paging message of a terminal group; and
a second receiving module, configured for receiving a paging message in the corresponding PDSCH time-frequency resource block according to the indication information.

According to a sixth aspect, embodiments of the present application provide an information processing device, applied to a network device, including:
a first determining module, configured for determining at least one indication information, where the indication information is configured to indicate at least one PDSCH time-frequency resource block that provides a paging message of a terminal group; and
a first sending module, configured for sending paging indication signal, where the paging indication signal includes the at least one indication information.

According to a seventh aspect, embodiments of the present application provide an information processing device, applied to a terminal device, including:
an obtaining module, configured for obtaining carrier indication information; and
a paging module, configured for receiving paging message according to the carrier indication information and a paging indication signal, where the paging indication signal includes at least one indication information, and the indication information is configured to indicate at least one PDSCH time-frequency resource block that provides a paging message of a terminal group.

According to an eighth aspect, embodiments of the present application provide an information processing device, applied to a network device, including:
a second determining module, configured for determining carrier indication information;
a second sending module, configured for sending the carrier indication information and a paging indication signal, where the paging indication signal includes at least one indication information, and the indication information is configured to indicate at least one PDSCH time-frequency resource block that provides a paging message of a terminal group.

According to a ninth aspect, embodiments of the present application provide a communication device, including:
a processor; and
a memory,
the memory stores computer-executable instructions, and when the computer-executable instructions are executed by the processor, the information processing method according to any one of the first aspect to the fourth aspect is implemented.

It should be noted that the communication device in the ninth aspect may be a terminal device or a network device, or may be a chip of the terminal device or a chip of the network device.

According to a tenth aspect, embodiments of the present application provide a computer readable storage medium, the computer-readable storage medium stores computer-executable instructions, and when the computer-executable instructions are executed by a processor, the information processing method according to any one of the first aspect to the fourth aspect is implemented.

According to an eleventh aspect, embodiments of the present application provide a program product. The program product includes computer programs stored on readable storage media, the processor can read the computer program from the readable storage medium, and the processor executes the computer program to implement the method according to any one of the first aspect to the fourth aspect.

Embodiments of the present application provide an information processing method, an information processing device, and a storage medium. The information processing method includes: receiving a paging indication signal, where the paging indication signal includes at least one indication information, and the indication information is configured to indicate at least PDSCH time-frequency resource block that provides a paging message of a terminal group; and receiving a paging message in the corresponding PDSCH time-frequency resource block according to the indication information. In this way, time-frequency resources can be configured more flexibly to meet application requirements in different scenarios. Moreover, the terminal device only needs to analyze the PDSCH time-frequency resource blocks corresponding to the group it belongs to, and does not need to analyze the PDSCH time-frequency resource blocks corresponding to all groups, thereby effectively saving the power of the terminal device.

### BRIEF DESCRIPTION OF THE DRAWINGS

The accompanying drawings, which are incorporated in and constitute a part of this specification, illustrate embodiments consistent with the application and together with the description serve to explain the principles of the application. In order to more clearly illustrate the technical solutions of the embodiments of the present application, the following will briefly introduce the drawings that need to be used in the description of the embodiments. Apparently, those skilled in the art can also obtain other drawings based on these drawings without any creative effort.

FIG. 1 is a schematic diagram of a hardware structure of a mobile terminal implementing various embodiments of the present application.

FIG. 2 is a system architecture diagram of a communication network according to an embodiment of the present application.

FIG. 3 is a schematic diagram of an application scenario according to an embodiment of the present application.

FIG. 4 is a schematic flowchart of an information processing method according to an embodiment of the present application.

FIG. 5 is a schematic diagram of a PDSCH time-frequency resource block according to an embodiment of the present application.

FIG. 6 is a schematic diagram of a frequency domain resource configuration according to an embodiment of the present application.

FIG. 7 is a schematic diagram of a time-domain resource configuration according to an embodiment of the present application.

FIG. 8 is a schematic diagram of a PDSCH time-frequency resource block in which different terminal groups use different time domains according to an embodiment of the present application.

FIG. 9 is a schematic diagram of a PDSCH time-frequency resource block in which different terminal groups use different frequency domains according to an embodiment of the present application.

FIG. 10 is a schematic diagram of a PDSCH time-frequency resource block in which different terminal groups use different time domains and frequency domains according to an embodiment of the present application.

FIG. 11 is a schematic diagram of an indication information according to an embodiment of the present application.

FIG. 12A is a schematic diagram of another indication information according to an embodiment of the present application.

FIG. 12B is a schematic diagram of another indication information according to an embodiment of the present application.

FIG. 12C is a schematic diagram of another indication information according to an embodiment of the present application.

FIG. 12D is a schematic diagram of another indication information according to an embodiment of the present application.

FIG. 13 is a schematic flowchart of receiving paging message according to an embodiment of the present application.

FIG. 14 is a schematic flowchart of another information processing method according to an embodiment of the present application.

FIG. 15 is a schematic flowchart of another information processing method according to an embodiment of the present application.

FIG. 16 is a schematic flowchart of another information processing method according to an embodiment of the present application.

FIG. 17 is a schematic structural diagram of an information processing device according to an embodiment of the present application.

FIG. 18 is a schematic structural diagram of another information processing device according to an embodiment of the present application.

FIG. 19 is a schematic structural diagram of another information processing device according to an embodiment of the present application.

FIG. 20 is a schematic structural diagram of another information processing device according to an embodiment of the present application.

FIG. 21 is a schematic structural diagram of a communication device according to an embodiment of the present application.

The realization, functional features and advantages of the present application will be further described in conjunction with the embodiments and with reference to the accompanying drawings. By means of the above drawings, specific embodiments of the present application have been shown, which will be described in more detail hereinafter. These drawings and text descriptions are not intended to limit the scope of the concept of the application in any way, but to illustrate the concept of the application for those skilled in the art by referring to specific embodiments.

### DETAILED DESCRIPTION OF THE EMBODIMENTS

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the present application. Rather, they are merely examples of devices and methods consistent with aspects of the present application as recited in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least a part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”. It should be noted that in this article, step codes such as S401 and S402 are used for the purpose of expressing the corresponding content more clearly and concisely, and do not constitute a substantive limitation on the order. Those skilled in the art may perform S402 first and then S401 etc. during specific implementation, but these should all be within the protection scope of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The mobile terminal can be implemented in various forms. For example, the mobile terminal described in the present application can include a mobile phone, a tablet computer, a notepad computer, a hand-held computer, a personal digital assistants (PDA), a portable media player (PMP), a navigation device, a wearable device, a smart bracelet, a pedometer and other mobile terminals, as well as a fixed terminal such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal.

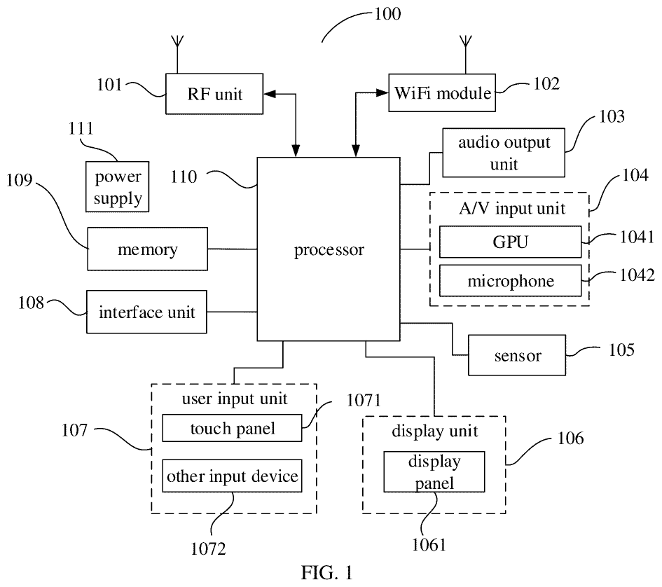

As shown in FIG. 1, FIG. 1 is a schematic structural diagram of a hardware of a mobile terminal according to embodiments of the present application. The mobile terminal 100 can include a Radio Frequency (RF) unit 101, a WiFi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a recording mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can also provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a recording mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switching, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated here.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and sends it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a Bluetooth module, or the like, which will not be repeated herein.

In order to facilitate the understanding of the embodiments of the present application, the following describes the communication network system on which the mobile terminal of the present application is based.

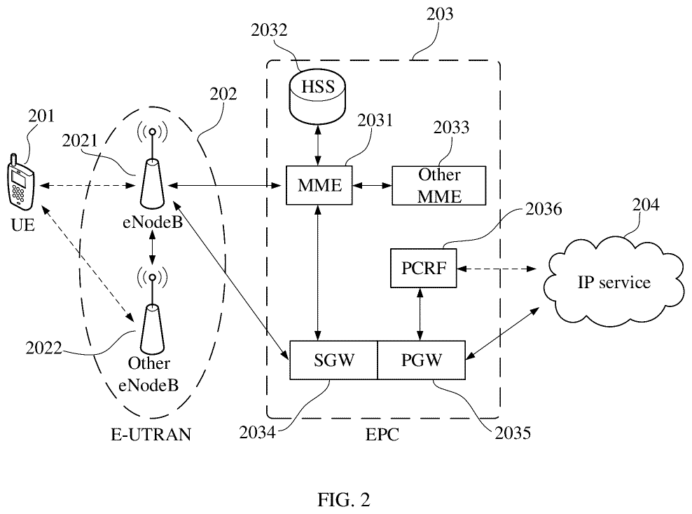

As shown in FIG. 2, FIG. 2 is an architecture diagram of a communication network system according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

Specifically, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMES 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, and new network systems in the future, or the like, which is not limited herein.

Based on the above mobile terminal hardware structure and communication network system, various embodiments of the present application are proposed.

First, an applicable application scenario of the present application is introduced.

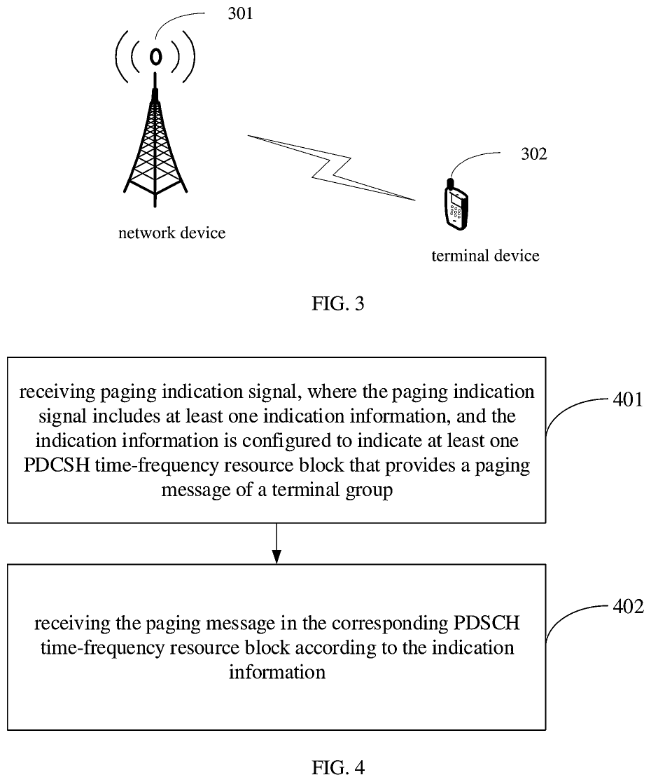

FIG. 3 is a schematic diagram of an application scenario according to an embodiment of the present application. Referring to FIG. 3, wireless communication can be performed between a network device 301 and a terminal device 302, so as to realize data transmission. The terminal device 302 can be the mobile terminal in FIG. 1, or other types of terminal devices. The network device 301 can be other devices in FIG. 2 other than the UE, such as a base station eNodeB.

The technical solutions in the embodiments of the present application can be applied to NR communication technology. NR refers to a new generation of wireless access network technology, which can be applied to future evolution networks, such as the fifth generation mobile communication (5G) system. The solutions in the embodiments of the present application can also be applied to other wireless communication networks such as wireless fidelity (WIFI) and long term evolution (LTE), and corresponding names can also be replaced with names of corresponding functions in other wireless communication networks.

The network architecture and business scenarios described in the embodiments of the present application are to more clearly illustrate the technical solutions of the embodiments of the present application, and do not constitute limitations on the technical solutions provided by the embodiments of the present application. Those skilled in the art know that with the evolution of the network architecture and the emergence of new service scenarios, the technical solutions provided in the embodiments of the present application are also applicable to similar technical problems.

In 5G communication, when the terminal device 302 is in an idle state or an inactive state, the network device 301 may initiate paging to the terminal device 302. The terminal device can wake up at a paging occasion (PO) and monitor whether there is a paging indication corresponding to the terminal device on the PDCCH, so as to determine whether there is paging message for the terminal device 302 on the PDSCH.

If there is paging message for the terminal device 302 on the PDSCH, the terminal device 302 parses the PDSCH on the resource block indicated by the PDCCH to obtain the paging message, finally, it is confirmed whether the content of the paging message matches the user equipment identity (UE identity), if the content of the paging message matches the UE identity, the paging message is responded to, and if the content of the paging message does not match the UE identity, the paging message is ignored or discarded.

In this paging mode, each awakened terminal device 302 monitors the same PDCCH and receives paging message on the same PDSCH time-frequency resource, which cannot distinguish different service requirements and lacks flexible configuration. Besides, since different terminal devices 302 need to receive paging message on the same time-frequency resource block, the network device 301 needs to transmit the paging message of each terminal device 302 on the time-frequency resource block, resulting in too large a time-frequency resource block that the terminal device 302 needs to parse, and the terminal device 302 consumes more power.

In order to implement paging configuration more flexibly and save power consumption of the terminal device 302, the present application provides an information processing method, which can configure PDSCH time-frequency resource blocks based on terminal groups. The network device 301 may send paging indication signal to the terminal device 302, the paging indication signal may indicate at least one PDSCH time-frequency resource block that provides the paging message of the terminal group, such that the terminal device 302 can receive paging message in the corresponding PDSCH time-frequency resource block, so that different service requirements can be distinguished, and time-frequency resources can be configured more flexibly. The terminal device 302 only needs to analyze the PDSCH time-frequency resource blocks corresponding to the group it belongs to, and does not need to analyze the PDSCH time-frequency resource blocks corresponding to all groups, which can effectively save the power of the terminal device 302.

The technical solutions of the embodiments of the present application and how the technical solutions of the present application solve the above technical problems will be described in detail below with specific embodiments. The following specific embodiments may be combined with each other, and the same or similar concepts or processes may not be repeated in some embodiments. Embodiments of embodiments of the present application will be described below with reference to the accompanying drawings.

FIG. 4 is a schematic flowchart of an information processing method according to an embodiment of the present application. The execution subject of the method in this embodiment may be a terminal device. As shown in FIG. 4, the method may include:

Operation 401, receiving a paging indication signal, where the paging indication signal includes at least one indication information, and the indication information is configured to indicate at least one PDSCH time-frequency resource block that provides a paging message of a terminal group.

In an embodiment, the paging indication signal may be any signal sent by the network device to the terminal device.

In an example, the paging indication signal may be downlink control information (DCI). The network device can send the DCI to the terminal device through the PDCCH, specifically DCI format 1_0 can be used, or a new DCI format can be defined. At least one PDSCH time-frequency resource block that provides the paging message for the terminal group is indicated through adding indication information in the DCI, the effect can be achieved by making small changes on the basis of the existing DCI, which can better forward compatibility and improve the applicability of the instructions.

In another example, the paging indication may be radio resource control (RRC) signaling. At least one PDSCH time-frequency resource block where the paging message of the terminal group is located can be indicated in advance through RRC signaling, such that the terminal device does not need to wait until the monitoring of the PDCCH is completed to determine the corresponding PDSCH time-frequency resource block, which improves the efficiency of the terminal device in parsing the PDSCH.

In another example, the above indication information can be configured in both DCI and RRC signaling. The RRC signaling is a one-time configuration mode, while the DCI can be changed dynamically. When there is a conflict between the time-frequency resource blocks indicated by the RRC signaling and the DCI, the indication of the DCI can prevail. In this way, the network device can first configure the corresponding time-frequency resource block for the terminal device through RRC signaling, and when the time-frequency resource block needs to change, it can re-instruct through the DCI, which improves the flexibility of configuration.

The paging indication signal may include at least one indication information to indicate at least one PDSCH time-frequency resource block that provides the paging message of the terminal group.

In an embodiment, the terminal group may refer to a group of terminal devices, and different terminal groups may correspond to the same PDSCH time-frequency resource block, or may correspond to different PDSCH time-frequency resource blocks. When any two or more terminal groups correspond to the same PDSCH time-frequency resource block, the two or more terminal groups can receive paging message on the same PDSCH time-frequency resource block. Similarly, when any two or more terminal groups correspond to different PDSCH time-frequency resource blocks, the two or more terminal groups can receive paging message on their respective PDSCH time-frequency resource blocks.

One terminal group may correspond to one PDSCH time-frequency resource block, or may correspond to multiple PDSCH time-frequency resource blocks. When corresponding to multiple PDSCH time-frequency resource blocks, the PDSCHs may be respectively analyzed on the multiple PDSCH time-frequency resource blocks to obtain paging message. One piece of indication information may indicate the PDSCH time-frequency resource blocks corresponding to one terminal group, or may indicate the PDSCH time-frequency resource blocks corresponding to multiple terminal groups. The paging indication signal received by the terminal device may contain one indication information or multiple indication information. The embodiment of the present application does not limit this.

In an embodiment, the at least one indication information may be used to indicate that at least one terminal group uses at least two PDSCH time-frequency resource blocks, such that different terminal groups can use different PDSCH time-frequency resource blocks, which improves the utilization rate of time-frequency resources and increases the flexibility of time-frequency resource configuration.

Operation 402, receiving a paging message in the corresponding PDSCH time-frequency resource block according to the indication information.

In an embodiment of the present application, the PDSCH time-frequency resource block may include resources in the frequency domain and the time domain. The length of one radio frame may be 10 ms, each radio frame may include 10 subframes, and each subframe may include one or more time slots.

In the LTE system, a subframe may contain 2 time slots, and in the NR system, a subframe may contain 1, 2, 4, 8 or 16 time slots.

In the time domain, each time slot may include 14 Orthogonal Frequency Division Multiplexing (OFDM) symbols. In the frequency domain, resources can be divided into multiple subcarriers with a subcarrier spacing (SCS) of a certain size. The possible types of SCS can refer to the related art, and will not be repeated here.

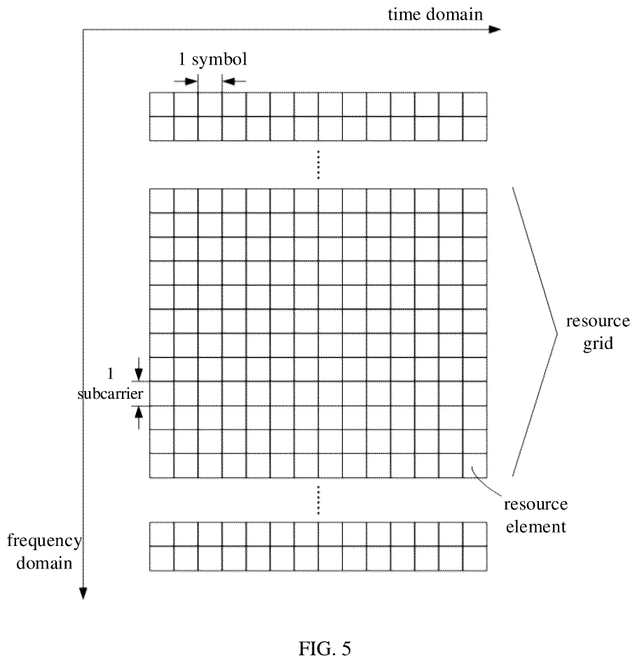

FIG. 5 is a schematic diagram of a PDSCH time-frequency resource block according to an embodiment of the present application. As shown in FIG. 5, resources are divided into resource grids in the time domain and frequency domain.

7 symbols in the time domain and 12 subcarriers in the frequency domain can constitute a standard resource block (RB), and each standard resource block may include 7*12=84 resource elements (RE).

In an embodiment, a standard RB may also be composed of 12 consecutive subcarriers in the frequency domain.

The PDSCH time-frequency resource block according to the embodiment of the present application may refer to one or more resource elements carrying PDSCH. For example, it may be a PDSCH time-frequency resource block composed of some REs in one RB in FIG. 5, or a PDSCH time-frequency resource block composed of some REs in multiple consecutive RBs.

It may also be a PDSCH time-frequency resource block composed of one complete sub-RB or multiple complete RBs.

The following describes how to configure time-frequency resources of the NR PDSCH. In the frequency domain, the network indicates the resources of the terminal in the frequency domain through RRC signaling or DCI. The first type is Type 0, which indicates the allocated frequency domain resources through a bit stream. When the bit is “1”, it means that the resource block group (RBG) is allocated to the terminal, and when the bit is “0”, it means that the RBG is not allocated to the terminal. The second type is Type 1, in which the network indicates resources in the frequency domain through a Resource Indication Value (RIV). The RBG is composed of consecutive RBs, for example, 2, 4, 8 or 16 RBs. Indicating resources in the frequency domain through the MV is to calculate the starting position of the resource block and the length of the continuously configured resources through the value of the MV. The starting position (RBₛₜₐᵣₜ) and the continuous length (L_{RBs}) on the frequency domain resource can be determined through the two calculated values, and the PDSCH time-frequency resource block on the time-frequency resource is obtained in units of RB. Regardless of the above two frequency-domain resource indication types (Type 0/Type 1), the PDSCH time-frequency resource block is formed in units of RBs.

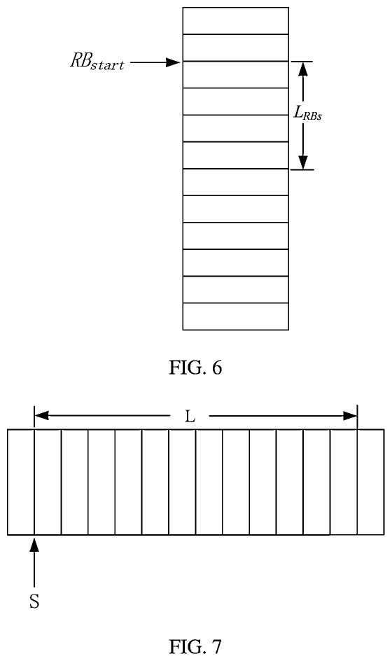

FIG. 6 is a schematic diagram of frequency domain resource configuration according to an embodiment of the present application. As shown in FIG. 6, the starting position RBₛₜₐᵣₜ of the frequency domain resources is the third RB, and the length is 4 RBs, then the resources in the frequency domain may include the third to seventh RBs.

In the time domain, it is indicated by the Start and Length Indicator (SLIV). The start symbol (S) and the allocation length (L) are calculated through SLIV, so the resource in the time domain of the PDSCH time-frequency resource block in a time slot can be known. For example, if S is 2 and L is 12, it means that the PDSCH time-frequency resource block uses a length of 12 symbols in the time domain, and the starting position is the second symbol.

FIG. 7 is a schematic diagram of time domain resource configuration according to an embodiment of the present application. As shown in FIG. 7, the start symbol S of the time domain resource is the second symbol, and the length L is 12 symbols, then the time domain resource may include the second to thirteenth symbols.

When different terminal groups use different PDSCH time-frequency resource blocks, it may be to use different resource blocks in the time domain, or to use different resource blocks in the frequency domain, or to use different resource blocks in both the time domain and the frequency domain.

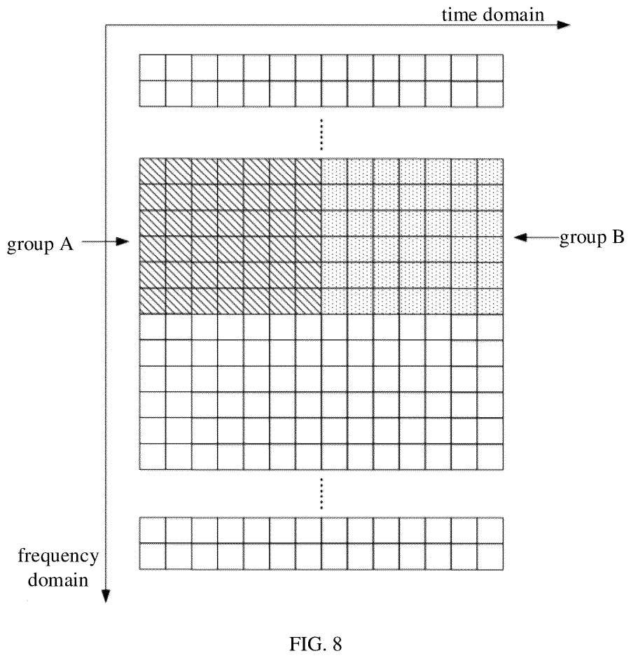

FIG. 8 is a schematic diagram of a PDSCH time-frequency resource block in which different terminal groups use different time domains according to an embodiment of the present application. As shown in FIG. 8, group A and group B may use different time-domain resources, the time-frequency resources used by group A are indicated by oblique hatching, and the time-frequency resources used by group B are indicated by dotted hatching.

In an embodiment, group A uses the first 7 symbols in the time slot, and group B uses the last 7 symbols in the time slot, so that paging message of different groups is carried on different time domain resources.

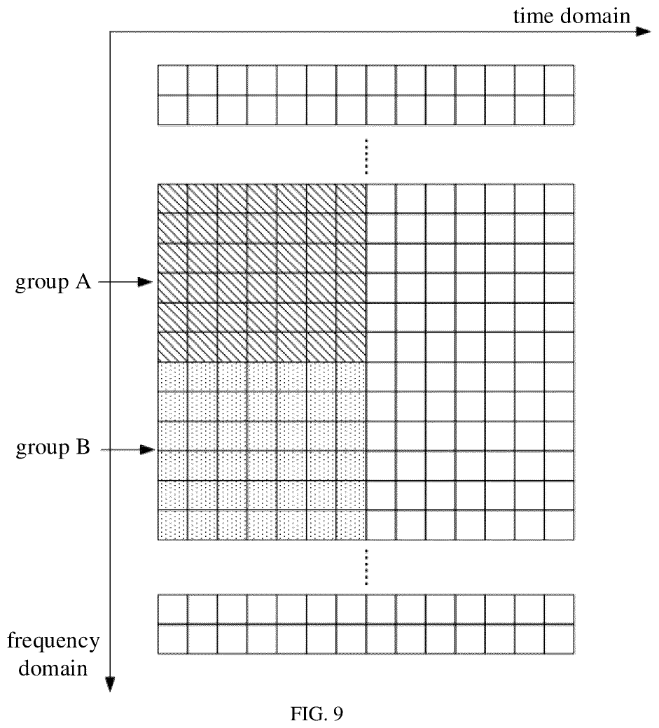

FIG. 9 is a schematic diagram of a PDSCH time-frequency resource block in which different terminal groups use different frequency domains according to an embodiment of the present application. As shown in FIG. 9, group A and group B may use different frequency domain resources. Group A uses the first 6 subcarriers, and group B uses the last 6 subcarriers, thereby carrying different paging message on different frequency domain resources.

FIG. 10 is a schematic diagram of PDSCH time-frequency resource blocks used by different terminal groups in different time domains and frequency domains according to an embodiment of the present application. As shown in FIG. 10, group A and group B may use different time domain and frequency domain resources. Group A uses the first 7 symbols and the first 6 subcarriers, and group B uses the last 7 symbols and the last 6 subcarriers, thereby carrying different paging message on different time domain and frequency domain resources.

Several examples in which different terminal groups use different PDSCH time-frequency resource blocks are given above, and the position and size of the PDSCH time-frequency resource blocks used by terminal devices can be adjusted according to actual needs.

For example, the number of symbols in the time domain of a PDSCH time-frequency resource block can be dynamically adjusted according to the amount of information, and similarly, the number of subcarriers in the frequency domain can also be set according to actual needs. The sizes of the PDSCH time-frequency resource blocks corresponding to different terminal groups may be the same or different.

After acquiring the indication information for indicating the PDSCH time-frequency resource block, the terminal device may receive paging message in the corresponding PDSCH time-frequency resource block. The corresponding PDSCH time-frequency resource block may refer to a PDSCH time-frequency resource block corresponding to the terminal group to which the terminal device belongs.

In practical applications, the network device can send a wake up signal (WUS) or a paging early indication (PEI) to terminal devices in an idle state or an inactive state to indicate whether the terminal group needs to monitor the PDCCH. Then, different terminal groups can monitor the PDCCH on the same time-frequency resource, and according to the detected DCI, group A confirms its own PDSCH time-frequency resource block, group B confirms its own PDSCH time-frequency resource block, group A and group B can receive PDSCH on different PDSCH time-frequency resource blocks to obtain paging message.

After acquiring the paging message, the terminal device determines whether the content of the paging message matches the identifier of the terminal device, and if so, responds to the paging message. The paging message carried on a PDSCH time-frequency resource block may contain the identifiers of one or more terminal devices, so that the paged terminal devices in the group can quickly respond to the corresponding paging message.

In an embodiment of the present application, according to different business needs, different groups of terminal devices can be woken up at the same time, and different paging message can be sent. The terminal device can use the same paging radio network temporary identifier (P-RNTI) when listening to the PDCCH, and there is no need to introduce a new temporary identifier code to increase complexity. The terminal device may monitor the PDCCH and receive the PDSCH in the same time slot or in different time slots.

The embodiment provides an information processing method, including: receiving a paging indication signal, the paging indication signal including at least one indication information, and the indication information is configured to indicate at least one PDSCH time-frequency resource block that provides the paging message of a terminal group; and receiving a paging message in the corresponding PDSCH time-frequency resource block according to the indication information. In this way, time-frequency resources can be configured more flexibly to meet application requirements in different scenarios. Moreover, the terminal device only needs to analyze the PDSCH time-frequency resource blocks corresponding to the group it belongs to, and does not need to analyze the PDSCH time-frequency resource blocks corresponding to all groups, thereby effectively saving the power of the terminal device.

On the basis of the technical solutions provided in the foregoing embodiments, the terminal group to which the terminal device belongs may be determined according to the type and/or the state of the terminal device.

In an example, the state of the terminal device may include an idle state and/or an inactive state. The terminal device can be divided into two groups through the idle state and the inactive state: the idle state group and the inactive state group. The terminal device can determine the group to which it belongs according to its state, and receive paging message according to the PDSCH time-frequency resource block corresponding to the group.

In an embodiment, the state of the terminal device may not be limited to the above two states, and more states may be set for the terminal device according to actual needs, so as to obtain more groups. By dividing terminal devices in different states into different groups, it is possible to send paging message to terminal devices in different states on different PDSCH time-frequency resource blocks, to distinguish different service requirements, and meet the needs of paging the terminal device in different states.

In another example, the type of the terminal device may include at least one of the following: a mobile terminal, an Internet of Things terminal (IOT equipment), a reduce capability terminal (NR light equipment), and an industrial IoT terminal (IIOT equipment). The terminal devices can be divided into multiple groups according to the types of the terminal devices, and different types can correspond to different groups.

In an embodiment, the mobile terminal may be a terminal as shown in FIG. 1. The Internet of Things terminal may be a terminal applied to the Internet of Things such as a smart home terminal, an Internet of Vehicles. The reduce capability terminal may be a simplified version, a lightweight version of the 5G NR terminal, or a wearable device, and the industrial IoT terminal may be a terminal applied to the Industrial Internet of Things. The types of terminal devices may not be limited to the above four modes, and more types of terminal devices may also be expanded according to actual scenarios.

By dividing different types of terminal devices into different groups, it is possible to send paging message to different types of terminal devices on different PDSCH time-frequency resource blocks, to distinguish different business requirements, and meet the needs of paging different types of terminal devices.

In another example, the terminal group to which the terminal device belongs can be jointly determined according to the type and the state of the terminal device. Taking the terminal device including 4 types and 2 states as an example, 4*2=8 terminal groups can be set. The terminal device can determine the terminal group it belongs to according to its own type and state, and use the PDSCH time-frequency resource block corresponding to the terminal group to receive paging message, such that group terminals are more finely divided, and the efficiency and accuracy of obtaining paging message are improved.

On the basis of the technical solutions provided in the foregoing embodiments, the indication information may include terminal group indication information and/or PDSCH time-frequency resource block information.

Firstly, an implementation manner in which the indication information includes terminal group indication information and PDSCH time-frequency resource block information will be described below.

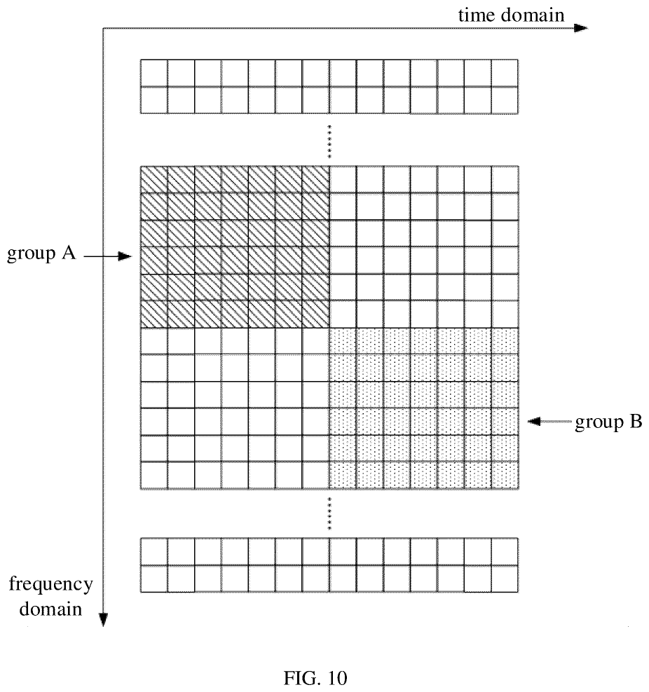

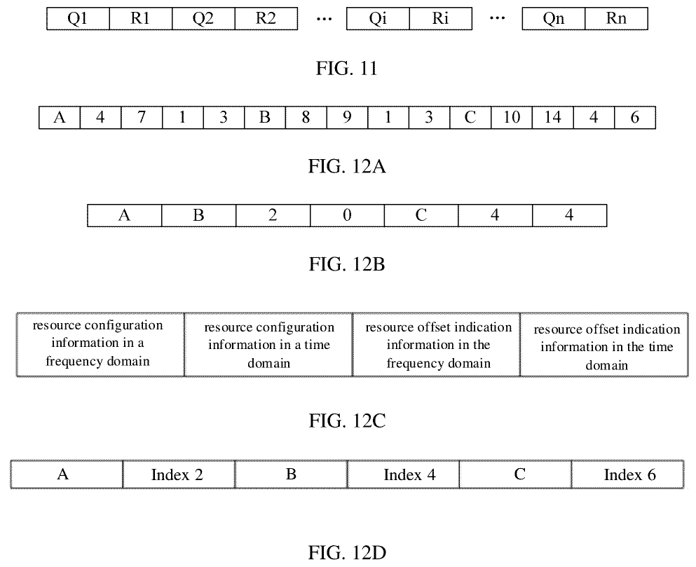

FIG. 11 is a schematic diagram of indication information according to an embodiment of the present application. As shown in FIG. 11, the indication information may include terminal group indication information Q1, Q2, . . . , Qi, . . . , Qn and PDSCH time-frequency resource block information R1, R2, . . . , Ri, . . . , Rn.

In an embodiment, Qi represents terminal group indication information corresponding to the i-th terminal group, and the terminal group indication information may be an identifier of the terminal group. Ri represents the PDSCH time-frequency resource block information corresponding to the i-th terminal group. The value of i is from 1 to n, n is the number of groups to be paged, and n≥1.

In an embodiment, the PDSCH time-frequency resource block information includes at least one of the following: resource configuration information in a frequency domain; resource configuration information in a time domain; resource offset indication information in the frequency domain; resource offset indication information in the time domain; an index of the resource block.

In an embodiment, the resource configuration information in the time domain may include the sequence number of the symbol and/or the number of symbols. The sequence number of the symbol may include the sequence number of the start symbol and/or the sequence number of the end symbol, respectively indicating the sequence number of the symbol at which the terminal group starts to receive the PDSCH and the sequence number of the symbol at which the terminal group ends receiving the PDSCH. The number of symbols indicates the number of symbols occupied by the PDSCH time-frequency resource blocks corresponding to the terminal group.

In an embodiment, SLIV can also be used to indicate the symbol used in the time domain. In an embodiment, the start time domain position and the sequence number of the start symbol may be confirmed through the received SLIV value, and the number of occupied symbols and the sequence number of the end symbol may be confirmed through the received SLIV value.

In an embodiment, the resource configuration information in the frequency domain may include the sequence number of the subcarrier and/or the number of the subcarrier. The sequence number of the subcarrier may include the sequence number of the start subcarrier and/or the sequence number of the end subcarrier, respectively representing the sequence numbers of the first subcarrier and the last subcarrier used, and the number of symbols represents the number of subcarriers occupied by the PDSCH time-frequency resource blocks corresponding to the terminal group.

In an embodiment, RIV or a bit string can also be used to indicate the subcarriers used in the frequency domain. The start frequency domain position and the sequence number of the start subcarrier may be confirmed through the received RIV value, and the number of occupied subcarriers and the sequence number of the end subcarrier in the frequency domain may be confirmed through the received RIV value. Or, the sequence number of the subcarrier used in the frequency domain and the number of occupied subcarriers are confirmed, and the sequence number of the start subcarrier and/or the sequence number of the end subcarrier are confirmed through a bit string.

FIG. 12A is a schematic diagram of another indication information according to an embodiment of the present application. As shown in FIG. 12A, the terminal groups include group A, group B, and group C, and the corresponding terminal group indication information is A, B, and C respectively. The PDSCH time-frequency resource block information may include resource configuration information in the frequency domain and resource configuration information in the time domain. The resource configuration information in the time domain may include the sequence number of the start symbol and the sequence number of the end symbol, and the resource configuration information in the frequency domain may include the sequence number of the start subcarrier and the sequence number of the end subcarrier.

As shown in FIG. 12A, group A uses the 4th to 7th symbols in the time domain, and uses the 1st to 3rd subcarriers in the frequency domain. Group B uses the 8th to 9th symbols in the time domain, and uses the 1st to 3rd subcarriers in the frequency domain. Group C uses the 10th to 14th symbols in the time domain, and uses the 4th to 6th subcarriers in the frequency domain.

In addition, the number of symbols can be used instead of the sequence number of the start symbol or the sequence number of the end symbol. When determining the sequence number of the start symbol/the sequence number of the end symbol, the sequence number of the end symbol/the sequence number of the start symbol can be determined by the number of symbols. When determining the sequence number of the start subcarrier/the sequence number of the end subcarrier, the sequence number of the end subcarrier/the sequence number of the start subcarrier may be determined by the number of subcarriers. For example, the PDSCH time-frequency resource block information corresponding to group A can be used to indicate: in the time domain, starting from the fourth symbol, the number of symbols is 3; in the frequency domain, starting from the first subcarrier, the number of subcarriers is 3. According to the sequence number and number of the beginning, the sequence number of the end can be determined.

Using the sequence number of the symbol and/or the number of symbols and the sequence number of the subcarrier and/or the number of subcarriers to represent the resource configuration information in the time domain and the frequency domain, respectively, can clearly indicate the position of the PDSCH time-frequency resource block in the time domain and the frequency domain, and improve the accuracy of receiving paging message.

On this basis, the default time-domain resource configuration can also be used, so that the resource configuration information on time-frequency can be omitted. Alternatively, the default frequency domain resource configuration can also be used, so that the resource configuration information in the frequency domain can be omitted. For example, by default, the PDSCH can be received from the 4th symbol in the time domain and ends at the 14th symbol. Then, only the resource configuration information in the frequency domain needs to be given in the indication information, thereby simplifying the configuration of the indication information and reducing the length of information transmission.

FIG. 12B is a schematic diagram of another indication information according to an embodiment of the present application. The PDSCH time-frequency resource block information may include resource offset indication information in the frequency domain and resource offset indication information in the time domain.

In an embodiment, the resource offset indication information is used to indicate the resource offset of any group relative to the reference group. The reference group may be a group specified from all terminal groups, or may be a group located at a specific position in the indication information, such as the first group in the indication information.

As shown in FIG. 12B, the first terminal group in the indication information is group A, which serves as a reference group for other groups, namely, group B and group C. Group A may use a default PDSCH time-frequency resource block, and the information after group B and group C indicates the offset of group B and group C relative to group A in time domain and frequency domain.

Assume that by default 2 symbols and 2 subcarriers are used per group. Group A uses the 1st and 2nd symbols and the 1st and 2nd subcarriers by default. Then, according to the indication information shown in FIG. 12B, group B is offset by 2 symbols in the time domain and 0 subcarriers in the frequency domain relative to group A, that is, group B uses the 3rd and 4th symbols and the 1st and 2nd subcarriers. Group C is shifted by 4 symbols in the time domain and by 4 subcarriers in the frequency domain relative to group A, that is, group B uses the 5th and 6th symbols and the 5th and 6th subcarriers.

In an embodiment, the PDSCH time-frequency resource blocks used by group A may not be default, but indicated by indication information. In this case, in the indication information, information for indicating the PDSCH time-frequency resource blocks of the group A may be added after the identifier of the group A.

On this basis, different groups can be set to use the same time domain resources, but the frequency domain resources are different, so that the resource offset indication information in the time domain can be omitted. Alternatively, different groups may be set to use the same frequency domain resources, but different time domain resources, so that resource offset indication information in the frequency domain may be omitted to reduce the length of information transmission.

In addition to indicating the resource offset relative to the reference group, the resource offset indication information may also be used to indicate the resource offset of the terminal group relative to other specific positions, for example, the resource offset relative to the PDCCH. In this way, after monitoring the PDCCH, according to the resource offset indication information, parsing of the PDSCH can be started on the resource block at the corresponding position.

The resource offset indication information can indicate the resource offset of the terminal group relative to the reference group or certain signals, which can reduce the configuration complexity to a certain extent. When the PDSCH time-frequency resource block corresponding to the reference group changes, but the relative offset between each terminal group does not change, it only needs to directly modify the PDSCH time-frequency resource block information of the reference group, which can effectively improve the efficiency and accuracy of determining the indication information.

FIG. 12C is a schematic diagram of another indication information according to an embodiment of the present application. The indication information includes resource configuration information in the frequency domain, resource configuration information in the time domain, resource offset indication information in the frequency domain, and resource offset indication information in the time domain.

In an example, the maximum range of the PDSCH resource block can be confirmed through the resource configuration information in the frequency domain and the resource configuration information in the time domain, and then the PDSCH resource block can be divided into multiple sub-PDSCH resource blocks through the resource offset indication information in the frequency domain. The multiple sub-PDSCH resource blocks do not overlap each other in the frequency domain. Different terminal groups may respectively correspond to each sub-PDSCH resource block according to the sequence, and determine the PDSCH resource block to be received. For example, the resource configuration information in the frequency domain and the resource configuration information in the time domain in the indication information indicate that the maximum range of the PDSCH resource block is 12 subcarriers in the frequency domain, its carrier number is 1 to 12, the length is 9 symbols in the time domain, its symbol number is 1 to 9, and the resource offset indication information in the frequency domain is set to 3, which can be expressed as dividing the frequency domain resource of the PDSCH resource block into 3 equal parts. Therefore, the PDSCH resource block is divided into three sub-PDSCH resource blocks in the frequency domain, which are respectively 1 to 4, 5 to 8, and 9 to 12, and respectively correspond to 3 different terminal groups.

In another example, the maximum range of the PDSCH resource block can be confirmed through the resource configuration information in the frequency domain and the resource configuration information in the time domain, and then the PDSCH resource block can be divided into multiple sub-PDSCH resource blocks through the resource offset indication information in the time domain. The multiple sub-PDSCH resource blocks do not overlap each other in the time domain. Different terminal groups may respectively correspond to each sub-PDSCH resource block according to the sequence, and determine the PDSCH resource block to be received. For example, the resource configuration information in the frequency domain and the resource configuration information in the time domain in the indication information indicate that the maximum range of the PDSCH resource block is 12 subcarriers in the frequency domain, the carrier number is 1 to 12, the length is 9 symbols in the time domain, the symbol number is 1 to 9, and the resource offset indication information in the time domain is set to 3, which can be expressed as dividing the time domain resources of the PDSCH resource block into 3 equal parts. Therefore, the PDSCH resource block is divided into three sub-PDSCH resource blocks in the time domain, which are respectively 1 to 3, 4 to 6, and 7 to 9, and respectively correspond to 3 different terminal groups.

In another example, the maximum range of the PDSCH resource block can be confirmed through the resource configuration information in the frequency domain and the resource configuration information in the time domain, then the PDSCH resource block can be divided into multiple sub-PDSCH resource blocks through the resource offset indication information in the frequency domain and the resource offset indication information in the time domain. The multiple sub-PDSCH resource blocks do not overlap with each other in frequency domain and time domain. Different terminal groups may respectively correspond to each sub-PDSCH resource block according to the sequence, and determine the PDSCH resource block to be received. For example, the resource configuration information in the frequency domain and the resource configuration information in the time domain in the indication information indicate that the maximum range of the PDSCH resource block is 12 subcarriers in the frequency domain, the carrier number is 1 to 12, the length is 6 symbols in the time domain, and its symbol number is 1 to 6, the resource offset indication information in the frequency domain is set to 2, and the resource offset indication information in the time domain is set to 2, which can be expressed as dividing the time domain resources of the PDSCH resource block into 4 equal parts. Therefore, the PDSCH resource block is divided into 4 sub-PDSCH resource blocks in the frequency domain and the time domain, the frequency domain is 1 to 6 and the time domain is 1 to 3, the frequency domain is 7 to 12 and the time domain is 1 to 3, the frequency domain is 1 to 6 and the time domain is 4 to 6, the frequency domain is 7 to 12 and the time domain is 4 to 6, and correspond to 4 different terminal groups respectively. The correspondence manner may be sequentially corresponding in the time domain, and vice versa, may be sequentially corresponding in the frequency domain.

According to the above several implementation methods, the maximum range of available PDSCH resource blocks can be confirmed through the resource configuration information, and then the PDSCH resource block can be divided into multiple sub-PDSCH resource blocks through the resource offset indication information, the terminal device can automatically divide the PDSCH resource blocks according to the indication information and select the sub-PDSCH resource blocks of the group to which it belongs, without adding terminal group indication information to the indication information, and reducing the transmission length of the indication information.

FIG. 12D is a schematic diagram of another indication information according to an embodiment of the present application. The PDSCH time-frequency resource block information may include an index of the resource block.

As shown in FIG. 12D, the PDSCH time-frequency resource block corresponding to group A is the resource block corresponding to index 2, the PDSCH time-frequency resource block corresponding to group B is the resource block corresponding to index 4, and the PDSCH time-frequency resource block corresponding to group C is the resource block corresponding to index 6.

For example, the resource block corresponding to index 2 may include the 4th to 7th symbols in the time domain and the 1st to 3rd subcarriers in the frequency domain. The resource block corresponding to index 4 may include the 8th to 9th symbols in the time domain and the 1st to 3rd subcarriers in the frequency domain. The resource block corresponding to index 6 may include the 10th to 14th symbols in the time domain and the 4th to 6th subcarriers in the frequency domain. Correspondingly, groups A, B, and C may respectively use time-frequency resources corresponding to their respective indexes.

In an embodiment, an index may correspond to a continuous PDSCH time-frequency resource block, or may correspond to multiple scattered PDSCH time-frequency resource blocks.

Through the method shown in FIG. 12D, an index can be assigned to an available resource block, and the corresponding resource block can be found through the index. There is no need to provide detailed resource configuration information in the time domain and frequency domain in the indication information, thereby effectively simplifying the indication information.

On the basis of the schemes shown in FIG. 12A, FIG. 12B, FIG. 12C and FIG. 12D, various schemes may also be combined to indicate resource blocks. As mentioned above, the information of the PDSCH time-frequency resource block can be selected from one or more of the following items:
resource configuration information in the frequency domain;
resource configuration information in the time domain;
resource offset indication information in the frequency domain;
resource offset indication information in the time domain; and
an index of the resource block.

The index of the resource block is not limited to the manner shown in the accompanying drawings.

In an embodiment, the resource in the frequency domain may be expressed in the form of RBG, that is, multiple consecutive RBs form an RBG, and the indication information may indicate the size of the resource in the frequency domain in the range of the RBG. The number of subcarriers included in one RB may be the number described above (12 consecutive subcarriers).

Exemplarily, in an indication information, group A may indicate the corresponding PDSCH time-frequency resource block through an index, and group B may indicate the corresponding PDSCH time-frequency resource block through resource offset indication information.

A possible situation is that the indication information includes information of multiple types of PDSCH time-frequency resource blocks, and repeated indications may occur. For example, the information of the PDSCH time-frequency resource block of the terminal group includes not only resource configuration information of the terminal group in the time domain and frequency domain, but also resource offset indication information in the time domain and frequency domain. Alternatively, the information of the PDSCH time-frequency resource block of the terminal group includes not only the index of the resource block, but also the resource configuration information of the terminal group in the time domain or frequency domain.

In an embodiment, when there are repeated indications, the terminal device can determine whether the content indicated by each information is consistent. If consistent, the paging message is received on the corresponding PDSCH time-frequency resource block, and/or, if not consistent, the paging message can be abandoned, so as to check the indication information and improve the accuracy of transmission.

Alternatively, if not consistent, the paging message can be received on the PDSCH time-frequency resource blocks indicated by each information, so as to avoid missing the paging message and improve the success rate of the terminal device being paged.

In an embodiment, when there are repeated indications, the indication of one of the information may also be taken as the default. The priority can be set for each type of information. For example, the priority of the index is higher than the priority of the resource configuration information, the priority of the resource configuration information is higher than the priority of the resource offset indication information. When the obtained indication information includes both the index of the resource block and other information, the index may prevail. Therefore, the terminal device receives paging message according to the PDSCH time-frequency resource block indicated by the preset type of information, taking into account both efficiency and accuracy.

Another possible situation is that the information of the PDSCH time-frequency resource block corresponding to the terminal group may omit part of the content. For example, information in the frequency or time domain can be omitted. In this case, for the omitted part, the default setting can be adopted, or it is consistent with the previous group, or it is consistent with the last time-frequency resource information. Therefore, the PDSCH time-frequency resource block information of the terminal group is indicated by omitting part of the content, and the information transmission length is reduced.

In other optional implementation manners, the indication information may include terminal group indication information, and the information of the PDSCH time-frequency resource block corresponding to the terminal group may adopt a default setting. For example, a default PDSCH time-frequency resource block can be configured through high-layer signaling, or, different PDSCH time-frequency resource blocks are pre-configured for different terminal groups according to the protocol, so that the information of the PDSCH time-frequency resource blocks can be omitted in the indication information.

In an embodiment, the high-layer signaling may also indicate to receive PDSCH resource blocks across time slots, thereby effectively reducing power consumption of the terminal device.

In an embodiment, the high-level signaling can also indicate the corresponding type in the time domain, specifically Type A or Type B, so that the terminal device can obtain channel estimation information through the indication of the high-level signaling, reducing DCI configuration complexity.

Alternatively, the indication information may include information of PDSCH time-frequency resource blocks, and the terminal group indication information may adopt a default setting. For example, the PDSCH time-frequency resource block information in the indication information may be assigned to the corresponding terminal group in a preset order by default, so that the terminal group indication information may be omitted in the indication information.

Exemplarily, the information of the PDSCH time-frequency resource blocks in the indication information may be set and allocated to groups A, B and C in sequence. When the information of the PDSCH time-frequency resource block includes index 2, index 4, and index 6, the terminal device may know that index 2, index 4, and index 6 are allocated to groups A, B, and C respectively. If the terminal device belongs to group B, it can use the PDSCH time-frequency resource block corresponding to index 4 to receive paging message.

Through the method described above, only terminal group indication information, or only PDSCH time-frequency resource block information may be configured in the indication information, the length of information transmission can be further reduced, thereby reducing signaling overhead and power consumption of terminal device.

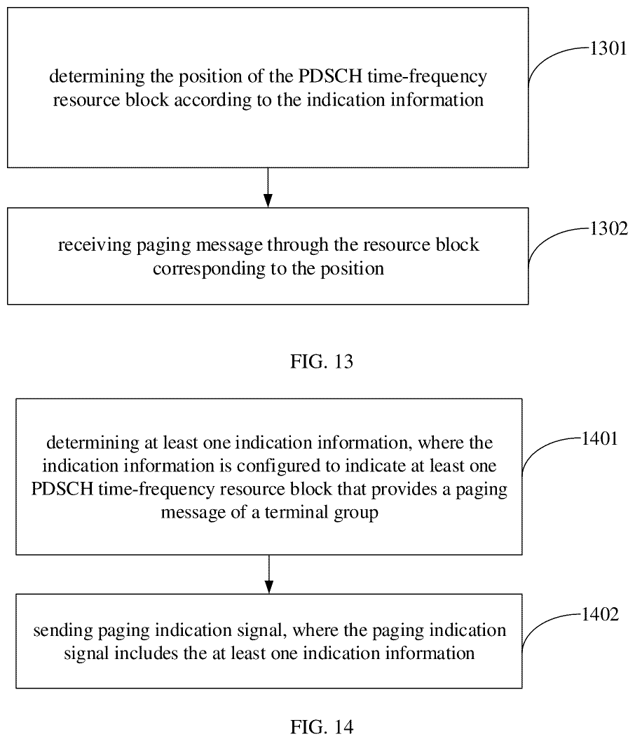

FIG. 13 is a schematic flowchart of receiving paging message according to an embodiment of the present application. As shown in FIG. 13, receiving paging message at the corresponding PDSCH time-frequency resource block according to the indication information may include:

Operation 1301, determining the position of the PDSCH time-frequency resource block according to the indication information.

Operation 1302, receiving paging message through the resource block corresponding to the position.

Through the indication information, the terminal device can determine the position of the corresponding PDSCH time-frequency resource block, and the position can specifically refer to the corresponding symbol position and/or subcarrier position. That is, the indication information can be used to determine which symbol and/or subcarrier the PDSCH time-frequency resource block starts from and which symbol and/or subcarrier ends. Therefore, the paging message is received at the resource block corresponding to the position, and the accuracy of receiving the paging message is improved.

In an embodiment, the terminal device may determine the position of the PDSCH time-frequency resource block by at least one of the following ways:
determine the position of the PDSCH time-frequency resource block according to the resource configuration information in the frequency domain;
determine the position of the PDSCH time-frequency resource block according to the resource configuration information in the time domain;
determine the position of the PDSCH time-frequency resource block according to the resource offset indication information in the frequency domain;
determine the position of the PDSCH time-frequency resource block according to the resource offset indication information in the time domain;
determine the position of the PDSCH time-frequency resource block according to the index of the resource block.

In this way, the position of the PDSCH time-frequency resource block can be determined in various ways, and the flexibility of resource configuration can be improved.

In practical applications, the network device may determine the position of at least one PDSCH time-frequency resource block for providing paging message of the terminal group, and generate the indication information according to the position of the PDSCH time-frequency resource block.

In an embodiment, the indication information may be determined by at least one of the following ways:
determine resource configuration information in the frequency domain according to the position of the PDSCH time-frequency resource block;
determine resource configuration information in the time domain according to the position of the PDSCH time-frequency resource block;
determining resource offset indication information in the frequency domain according to the position of the PDSCH time-frequency resource block;
determine resource offset indication information in the time domain according to the position of the PDSCH time-frequency resource block;
determine the index of the resource block according to the position of the PDSCH time-frequency resource block.

In an embodiment, the terminal device and the network device can store the correspondence between the position of the PDSCH time-frequency resource block and the information of the PDSCH time-frequency resource block in the indication information. For example, both the terminal device and the network device store the correspondence between the index and the position of the resource block, and the network device can search for the index corresponding to the position of the resource block and generate indication information according to the correspondence. The terminal device can analyze and process the indication information according to the correspondence to obtain the corresponding resource block position, so as to ensure the information consistency between the network device and the terminal device.

FIG. 14 is a schematic flowchart of another information processing method according to an embodiment of the present application. The execution subject of the method in this embodiment may be a network device. As shown in FIG. 14, the method includes:

Operation 1401, determining at least one indication information, where the indication information is configured to indicate at least one PDSCH time-frequency resource block that provides a paging message of a terminal group.

Operation 1402, sending paging indication signal, where the paging indication signal includes the at least one indication information.

The information processing method provided by this embodiment can determine at least one indication information, where the indication information is configured to indicate at least one PDSCH time-frequency resource block that provides the paging message of the terminal group, and send the paging indication signal, where the paging indication signal includes the at least one indication information. In this way, time-frequency resources can be configured more flexibly to meet application requirements in different scenarios. Besides, the terminal device only needs to analyze the PDSCH time-frequency resource blocks corresponding to the group it belongs to, and does not need to analyze the PDSCH time-frequency resource blocks corresponding to all groups, thereby effectively saving the power of the terminal device.

In an embodiment, the method further includes:
determining the position of at least one PDSCH time-frequency resource block for providing paging message of the terminal group; and
generating the indication information according to the position of the PDSCH time-frequency resource block.

In an embodiment, the method further includes at least one of the following:
the paging indication signal is DCI or RRC signaling;
the terminal group is determined by a type and/or a state of the terminal device;
the at least one indication information is configured to instruct at least one terminal group to use at least two PDSCH time-frequency resource blocks.

In an embodiment, the state of the terminal device includes an idle state and/or an inactive state; and/or the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the indication information is determined by at least one of the following ways:
determining the resource configuration information in the frequency domain according to a position of the PDSCH time-frequency resource block;
determining the resource configuration information in the time domain according to the position of the PDSCH time-frequency resource block;
determining the resource offset indication information in the frequency domain according to the position of the PDSCH time-frequency resource block;
determining the resource offset indication information in the time domain according to the position of the PDSCH time-frequency resource block;
determining the index of the resource block according to the position of the PDSCH time-frequency resource block.

In an embodiment, at least one of the following is includes:
the resource offset indication information is configured to indicate a resource offset of any group relative to a reference group;
the resource configuration information in the frequency domain includes a sequence number of a subcarrier and/or a number of subcarriers;
the resource configuration information in the time domain includes a sequence number of a symbol and/or a number of symbols.

The specific implementation principles and technical effects of the method provided in this embodiment are similar to those of the foregoing embodiments, and details will not be repeated here in this embodiment.

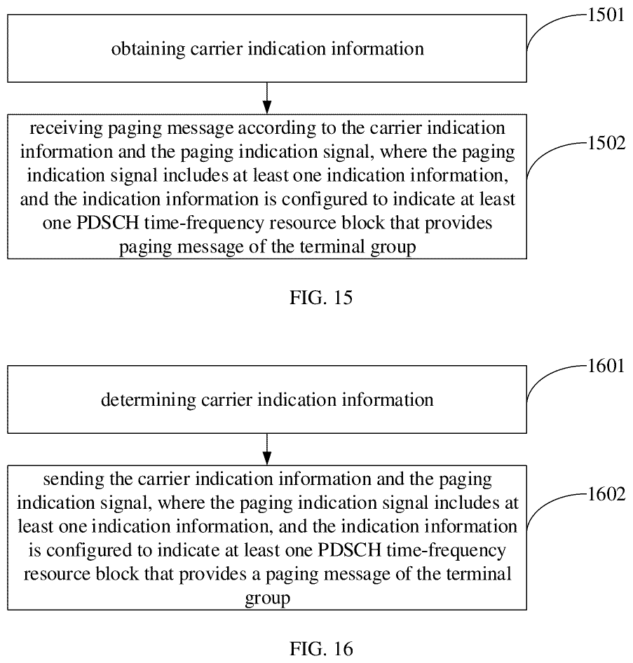

FIG. 15 is a schematic flowchart of another information processing method according to an embodiment of the present application. The execution subject of the method in this embodiment may be a terminal device. As shown in FIG. 15, the method may include:

Operation 1501, obtaining carrier indication information.

In an embodiment, the carrier indication information may be any information for indicating the carrier, including but not limited to at least one of the following: a frequency band of the carrier, a center frequency of the carrier, an identifier of the carrier, and the like. The carrier may be a carrier for receiving paging message.

The carrier indication information may be acquired from a network device, or may be acquired in other ways, for example, the carrier indication information stored in a memory may be acquired.

Operation 1502, receiving paging message according to the carrier indication information and the paging indication signal, where the paging indication signal includes at least one indication information, and the indication information is configured to indicate at least one PDSCH time-frequency resource block that provides the paging message of the terminal group.

In an embodiment, the carrier indication information can indicate the carrier receiving the paging message, and the paging indication signal can indicate the PDSCH time-frequency resource block receiving the paging message. Different terminal groups may use different PDSCH time-frequency resource blocks, and the PDSCH time-frequency resource blocks may include resources in the time domain and frequency domain. Since the paging indication signal includes subcarrier information in the frequency domain, the specific frequency for receiving paging message can be determined based on the carrier indication information and the paging indication signal.

For example, assuming that the carrier indication information indicates the use of carrier A, and the paging indication signal indicates the use of the 3rd to 6th subcarriers in the frequency domain, then the specific frequencies corresponding to the 3rd to 6th subcarriers can be determined according to information such as the frequency band of the carrier A and the subcarrier spacing, and the paging message can be received according to the frequencies.

In this embodiment, the specific concepts and principles of the paging indication signal, indication information, paging message, and PDSCH time-frequency resource blocks can refer to the foregoing embodiments, and will not be repeated herein.

The information processing method provided by this embodiment includes obtaining the carrier indication information, and receiving the paging message according to the carrier indication information and the paging indication signal, where the paging indication signal includes at least one indication information, and the indication information is configured to indicate at least one PDSCH time-frequency resource block that provides the paging message of the terminal group. Thus, the time-frequency resources can be configured more flexibly based on carrier indication information and paging indication signals to meet application requirements in different scenarios. The terminal device only needs to analyze the PDSCH time-frequency resource blocks corresponding to the group it belongs to, and does not need to analyze the PDSCH time-frequency resource blocks corresponding to all groups, thereby effectively saving the power of the terminal device.

On the basis of the technical solutions provided in the foregoing embodiments, consider the scenario as a dual connectivity (DC) scenario, the carrier indication information may include at least one of the following: master carrier information; secondary carrier information; master cell group (MCG) information; secondary cell group (SCG) information.

In an embodiment, the master carrier information may be any information capable of indicating the master carrier, including but not limited to at least one of the following: a frequency band of the master carrier, a center frequency of the master carrier, an identifier of the master carrier, and the like.

In an embodiment, the secondary carrier information may be any information capable of indicating the secondary carrier, including but not limited to at least one of the following: a frequency band of the secondary carrier, a center frequency of the secondary carrier, an identifier of the secondary carrier, and the like.

In an embodiment, the master cell group information may be any information capable of indicating the master cell group, including but not limited to at least one of the following: an identifier of the master cell group, an identifier of a cell included in the master cell group, and the like.

In an embodiment, the secondary cell group information may be any information capable of indicating the secondary cell group, including but not limited to at least one of the following: an identifier of a secondary cell group, an identifier of a cell included in the secondary cell group, and the like. Optionally, each cell group may include at least one cell.

In an embodiment, the master carrier of the master cell group and the secondary cell group may also be called a special cell (SpCell). Optionally, the master carrier of the secondary cell group may also be called a primary secondary cell (PSCell).

In an embodiment, after the carrier indication information is acquired, the paging message may be received according to the cell group and/or the carrier indicated in the carrier indication information.

In an optional implementation manner, the carrier indication information may include: master carrier information, secondary carrier information, master cell group information, secondary cell group information. That is, the carrier indication information not only indicates the master carrier and the secondary carrier, but also indicates the master cell group and the secondary cell group, the terminal device may receive paging message based on the master carrier and the secondary carrier of the master cell group and the secondary cell group.

In an embodiment, the paging message may be simultaneously received based on the master carrier in the master cell group, the secondary carrier in the master cell group, the master carrier in the secondary cell group, and the secondary carrier in the secondary cell group. Or, the paging message may be received based on part of the cell groups or part of the carriers, for example, the paging message may be received only based on the indicated master cell group, or the paging message may be received only based on the indicated master carrier.

In an embodiment, the paging message may be received in combination with the PDSCH time-frequency resource block indicated by the paging indication signal. For example, the paging message may be received through the PDSCH time-frequency resource block of the master carrier of the master cell group, and the position of the PDSCH time-frequency resource block is determined by the paging indication signal.

By indicating the master carrier, the secondary carrier, the master cell group, and the secondary cell group through carrier indication information, the terminal device timely obtains information such as the master carrier, the secondary carrier, the master cell group, and the secondary cell group required for receiving the paging message, thereby improving the accuracy and flexibility of the terminal device receiving the paging message.

In another optional implementation manner, the carrier indication information may include master carrier information and/or secondary carrier information without including master cell group information and secondary cell group information.

Correspondingly, the terminal device may receive paging message based on the master carrier and/or secondary carrier indicated by the carrier indication information. For example, the paging message may be received based on the master carrier; or, the paging message may be received based on the secondary carrier; or, the paging message may be received simultaneously based on the master carrier and the secondary carrier.

In yet another optional implementation manner, the carrier indication information may include master cell group information and/or secondary cell group information without including master carrier information and secondary carrier information.

Correspondingly, the terminal device may receive paging message based on the master cell group and/or the secondary cell group indicated by the carrier indication information. For example, the paging message may be received based on the master cell group; or, the paging message may be received based on the secondary cell group; or, the paging message may be received simultaneously based on the master cell group and the secondary cell group.

In an embodiment, each cell group may correspond to one or more carriers. When receiving paging message based on a certain cell group, specifically, the paging message may be received based on all or part of the carriers corresponding to the cell group.

In an embodiment, the carrier indication information may also include other combinations, for example, may include master carrier information and master cell group information, and the terminal device may receive paging message based on the master carrier of the master cell group.

The carrier indication information indicates part of information in the master carrier, the secondary carrier, the master cell group, and the secondary cell group, which can improve the flexibility of the paging method.

For example, when one of the carriers has a poor signal or greater interference, another carrier may be used for paging, so as to improve the paging success rate.

For example, when the signal of one group of carrier groups is poor or the interference is relatively large, another carrier group may be used for paging, so as to improve the paging success rate.

In an embodiment, before receiving the paging message according to the carrier indication information and the paging indication signal, the method may further include: acquiring paging indication signal.

In an embodiment, the order of acquiring the carrier indication information and acquiring the paging indication signal can be set according to actual needs. Optionally, the carrier indication information may be acquired first, and then the paging indication signal may be acquired; or, the paging indication signal may be acquired first, and then the carrier indication information may be acquired; or, the carrier indication information and the paging indication signal may be acquired simultaneously.

In an embodiment, the paging indication signal is acquired first, and then the carrier indication information is acquired, and the carrier indication information may also be indicated through a wake-up signal.

For example, the PDSCH time-frequency resource block for receiving the paging message is determined through the paging indication signal, and then the carrier indication information is confirmed through the wake-up signal, and the paging message is received on the PDSCH time-frequency resource block on the corresponding carrier, which can prepare for receiving paging message in advance and improve the flexibility of terminal device.

The paging indication signal can be obtained from a network device. By acquiring the paging indication signal, the terminal device can acquire the PDSCH time-frequency resource block for receiving the paging message in time, thereby improving the efficiency and accuracy of receiving the paging message.

In an embodiment, receiving paging message according to the carrier indication information and the paging indication signal may include: determining the position of the PDSCH time-frequency resource block according to the carrier indication information and the paging indication signal; receiving paging message through the resource block corresponding to the position.

In an embodiment, the terminal device can determine the carrier for receiving the paging message based on the carrier indication information, and then determine the position of the corresponding PDSCH time-frequency resource block according to the determined carrier and the paging indication signal. The position may specifically refer to a corresponding symbol position and/or a subcarrier position. That is, the symbol and/or subcarrier from which the PDSCH time-frequency resource block starts and ends with which symbol and/or subcarrier the PDSCH time-frequency resource block can be determined through the paging indication signal, so as to receive paging message at the resource block corresponding to the position.

Since the carrier indication information is referred to when determining the position of the PDSCH time-frequency resource block, different positions of the PDSCH time-frequency resource block can be obtained based on different carrier indication information configurations, which improves the flexibility of receiving paging message.

In an embodiment, the carrier indication information is RRC signaling. Indicating the carrier information through the RRC signaling can enable the terminal device to determine in advance the carrier information required to receive paging message, and improve the processing efficiency of the terminal device.

In an embodiment, the paging indication signal is DCI or RRC signaling; the terminal group to which it belongs can be determined according to the type and/or state of the terminal device; the at least one indication information is configured to instruct at least one terminal group to use at least two PDSCH time-frequency resource blocks.

In an embodiment, the state of the terminal device includes an idle state and/or an inactive state; and/or, the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following: resource configuration information in the frequency domain; resource configuration information in the time domain; resource offset indication information in the frequency domain; resource offset indication information in the time domain; index of resource block.

In an embodiment, the position of the PDSCH time-frequency resource block is determined by at least one of the following ways:
determining the position of the PDSCH time-frequency resource block according to the resource configuration information in the frequency domain;
determining the position of the PDSCH time-frequency resource block according to the resource configuration information in the time domain;
determining the position of the PDSCH time-frequency resource block according to the resource offset indication information on the frequency domain;
determining the position of the PDSCH time-frequency resource block according to the resource offset indication information in the time domain;
determining the position of the PDSCH time-frequency resource block according to the index of the resource block.

In an embodiment, the resource offset indication information is configured to indicate the resource offset of any group relative to the reference group; the resource configuration information in the frequency domain includes a subcarrier number and/or the number of subcarriers; the resource configuration information in the time domain includes a symbol number and/or the number of symbols.

In this embodiment, concepts or processes that have appeared in other embodiments are not described again. For specific principles and effects, reference may be made to other embodiments.

FIG. 16 is a schematic flowchart of another information processing method according to an embodiment of the present application. The execution subject of the method in this embodiment may be a network device. As shown in FIG. 16, the method may include:

Operation 1601, determining carrier indication information.

In an embodiment, the carrier indication information is used for the terminal device to determine the carrier for receiving the paging message. In an embodiment, corresponding carrier indication information may be configured for each terminal device, or corresponding carrier indication information may be configured for each group of terminal devices.

Operation 1602, sending the carrier indication information and the paging indication signal, where the paging indication signal includes at least one indication information, and the indication information is configured to indicate at least one PDSCH time-frequency resource block that provides a paging message of the terminal group.

In an embodiment, the sending sequence of the carrier indication information and the paging indication signal may be set according to actual needs. The carrier indication information can be sent first, and then the paging indication signal can be sent; or, the paging indication signal can be sent first, and then the carrier indication information can be sent; or, the carrier indication information and the paging indication signal can be sent simultaneously.

The information processing method provided by this embodiment includes: determining carrier indication information; and sending the carrier indication information and the paging indication signal, where the paging indication signal includes at least one indication information, and the indication information is configured to indicate at least one PDSCH time-frequency resource block that provides the paging message of the terminal group. Thus, the time-frequency resources can be configured more flexibly based on carrier indication information and paging indication signals to meet application requirements in different scenarios. The terminal device only needs to analyze the PDSCH time-frequency resource blocks corresponding to the group it belongs to, and does not need to analyze the PDSCH time-frequency resource blocks corresponding to all groups, thereby effectively saving the power of the terminal device.

In an embodiment, the carrier indication information includes at least one of the following: master carrier information; secondary carrier information; master cell group information; secondary cell group information.

In an embodiment, the method further includes: determining the position of at least one PDSCH time-frequency resource block for providing paging message of the terminal group; and generating the indication information according to the position of the PDSCH time-frequency resource block.

In an embodiment, the paging indication signal is DCI or RRC signaling; the carrier indication information is RRC signaling; the terminal group is determined by the type and/or state of the terminal device; the at least one indication information is configured to instruct at least one terminal group to use at least two PDSCH time-frequency resource blocks.

In an embodiment, the state of the terminal device includes an idle state and/or an inactive state; and/or, the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the information of the PDSCH time-frequency resource block includes at least one of the following:
resource configuration information in the frequency domain;
resource configuration information in the time domain;
resource offset indication information in the frequency domain;
resource offset indication information in the time domain;
the index of the resource block.

In an embodiment, the indication information is determined by at least one of the following ways:
determining resource configuration information in the frequency domain according to the position of the PDSCH time-frequency resource block;
determining resource configuration information in the time domain according to the position of the PDSCH time-frequency resource block;
determining resource offset indication information in the frequency domain according to the position of the PDSCH time-frequency resource block;
determining resource offset indication information in the time domain according to the position of the PDSCH time-frequency resource block;
determining the index of the resource block according to the position of the PDSCH time-frequency resource block.

In an embodiment, the resource offset indication information is configured to indicate a resource offset of any group relative to a reference group; the resource configuration information in the frequency domain includes a subcarrier number and/or the number of subcarriers; the resource configuration information in the time domain includes a symbol number and/or the number of symbols.

For the principle, process and effect of the method in this embodiment, reference may be made to the foregoing embodiments, and details are not repeated here.

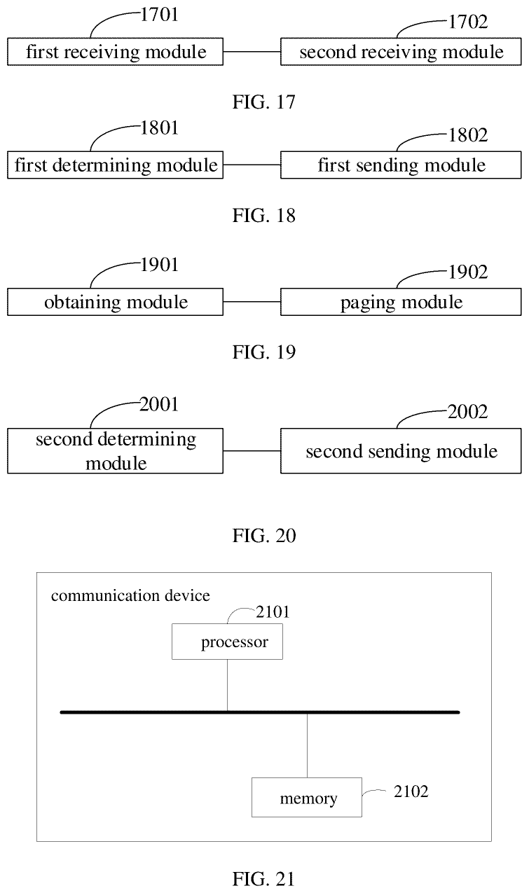

FIG. 17 is a schematic structural diagram of an information processing device according to an embodiment of the present application. The information processing device can be applied to a terminal device. As shown in FIG. 17, the information processing device may include a first receiving module 1701 and a second receiving module 1702.

The first receiving module 1701 is configured for receiving a paging indication signal, where the paging indication signal includes at least one indication information, and the indication information is configured to indicate at least one physical downlink share channel (PDSCH) time-frequency resource block that provides the paging message of a terminal group.

The second receiving module 1702 is configured for receiving a paging message in the corresponding PDSCH time-frequency resource block according to the indication information.

In an embodiment, the second receiving module 1702 is further configured for:
determining a position of the PDSCH time-frequency resource block according to the indication information; and
receiving the paging message through the resource block corresponding to the position.

In an embodiment, the paging indication signal is downlink control information (DCI) or radio resource control (RRC) signaling.

In an embodiment, the terminal group to which it belongs is determined according to a type and/or a state of the terminal device.

In an embodiment, the at least one indication information is configured to instruct at least one terminal group to use at least two PDSCH time-frequency resource blocks.

In an embodiment, the state of the terminal device includes an idle state and/or an inactive state; and/or

the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the position of the PDSCH time-frequency resource block is determined by at least one of the following ways:
determining the position of the PDSCH time-frequency resource block according to the resource configuration information in the frequency domain;
determining the position of the PDSCH time-frequency resource block according to the resource configuration information in the time domain;
determining the position of the PDSCH time-frequency resource block according to the resource offset indication information in the frequency domain;
determining the position of the PDSCH time-frequency resource block according to the resource offset indication information in the time domain;
determining the position of the PDSCH time-frequency resource block according to the index of the resource block.

In an embodiment, the resource offset indication information is configured to indicate a resource offset of any group relative to a reference group.

In an embodiment, the resource configuration information in the frequency domain includes a sequence number of a subcarrier and/or a number of subcarriers.

In an embodiment, the resource configuration information in the time domain includes a sequence number of a symbol and/or a number of symbols.

The device provided in this embodiment can be used to implement the technical solutions of the terminal device side method embodiments shown in FIG. 4 to FIG. 13, and its implementation principles and technical effects are similar, so this embodiment will not repeat them here.

FIG. 18 is a schematic structural diagram of another information processing device according to an embodiment of the present application. The information processing device can be applied to a network device. As shown in FIG. 18, the information processing device may include a first determining module 1801, and a first sending module 1802.

The first determining module 1801 is configured for determining at least one indication information, where the indication information is configured to indicate at least one PDSCH time-frequency resource block that provides the paging message of a terminal group.

The first sending module 1802 is configured for sending paging indication signal, where the paging indication signal includes the at least one indication information.

In an embodiment, the first determining module 1801 is further configured for:
determining a position of at least one PDSCH time-frequency resource block for providing paging message of the terminal group; and
generating the indication information according to the position of the PDSCH time-frequency resource block.

In an embodiment, the paging indication signal is downlink control information (DCI) or radio resource control (RRC) signaling.

In an embodiment, the terminal group is determined by a type and/or a state of the terminal device.

In an embodiment, the at least one indication information is configured to instruct at least one terminal group to use at least two PDSCH time-frequency resource blocks.

In an embodiment, the state of the terminal device includes an idle state and/or an inactive state; and/or

the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the indication information is determined by at least one of the following ways:
determining the resource configuration information in the frequency domain according to a position of the PDSCH time-frequency resource block;
determining the resource configuration information in the time domain according to the position of the PDSCH time-frequency resource block;
determining the resource offset indication information in the frequency domain according to the position of the PDSCH time-frequency resource block;
determining the resource offset indication information in the time domain according to the position of the PDSCH time-frequency resource block;
determining the index of the resource block according to the position of the PDSCH time-frequency resource block.

In an embodiment, the resource offset indication information is configured to indicate a resource offset of any group relative to a reference group.

In an embodiment, the resource configuration information in the frequency domain includes a sequence number of a subcarrier and/or a number of subcarriers.

In an embodiment, the resource configuration information in the time domain includes a sequence number of a symbol and/or a number of symbols.

The device provided in this embodiment can be used to execute the technical solution of the network device side method embodiment shown in FIG. 14, and its implementation principle and technical effect are similar, so this embodiment will not repeat them here.

FIG. 19 is a schematic structural diagram of another information processing device according to an embodiment of the present application. The information processing device can be applied to a terminal device. As shown in FIG. 19, the information processing device may include an obtaining module 1901 and a paging module 1902.

The obtaining module 1901 is configured for obtaining carrier indication information.

The paging module 1902 is configured for receiving paging message according to the carrier indication information and a paging indication signal, where the paging indication signal includes at least one indication information, and the indication information is configured to indicate at least one PDSCH time-frequency resource block that provides the paging message of a terminal group.

In an embodiment, the carrier indication information includes at least one of the following:
master carrier information;
secondary carrier information;
master cell group information;
secondary cell group information.

In an embodiment, before the paging module 1902 is configured for receiving the paging message according to the carrier indication information and the paging indication signal, the paging module 1902 is configured for:
obtaining the paging indication signal.

In an embodiment, the paging module 1902 is further configured for:
determining a position of the PDSCH time-frequency resource block according to the carrier indication information and the paging indication signal; and
receiving the paging message through the resource block corresponding to the position.

In an embodiment, the paging indication signal is downlink control information (DCI) or radio resource control (RRC) signaling; the carrier indication information is RRC signaling; the paging module 1902 is further configured for: determining the terminal group to which it belongs according to a type and/or a state of the terminal device; the at least one indication information is configured to instruct at least one terminal group to use at least two PDSCH time-frequency resource blocks.

In an embodiment, the state of the terminal device includes an idle state and/or an inactive state; and/or
the type of the terminal device includes at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the position of the PDSCH time-frequency resource block is determined by at least one of the following ways:
determining the position of the PDSCH time-frequency resource block according to the resource configuration information in the frequency domain;
determining the position of the PDSCH time-frequency resource block according to the resource configuration information in the time domain;
determining the position of the PDSCH time-frequency resource block according to the resource offset indication information in the frequency domain;
determining the position of the PDSCH time-frequency resource block according to the resource offset indication information in the time domain;
determining the position of the PDSCH time-frequency resource block according to the index of the resource block.

In an embodiment, the resource offset indication information is configured to indicate a resource offset of any group relative to a reference group; the resource configuration information in the frequency domain includes a sequence number of a subcarrier and/or a number of subcarriers; the resource configuration information in the time domain includes a sequence number of a symbol and/or a number of symbols.

The device provided in this embodiment can be used to execute the technical solution of the embodiment shown in FIG. 15, and its implementation principle and technical effect are similar, and details will not be repeated here in this embodiment.

FIG. 20 is a schematic structural diagram of another information processing device according to an embodiment of the present application. The information processing device can be applied to a network device. As shown in FIG. 20, the information processing device may include a second determining module 2001 and a second sending module 2002.

The second determining module 2001 is configured for determining carrier indication information.

The second sending module 2002 is configured for sending the carrier indication information and paging indication signal, where the paging indication signal includes at least one indication information, and the indication information is configured to indicate at least one PDSCH time-frequency resource block that provides the paging message of a terminal group.

In an embodiment, the carrier indication information includes at least one of the following:
master carrier information;
secondary carrier information;
master cell group information;
secondary cell group information.

In an embodiment, the second determining module 2001 is further configured for:
determining a position of at least one PDSCH time-frequency resource block for providing paging message of the terminal group; and
generating the indication information according to the position of the PDSCH time-frequency resource block.

In an embodiment, the paging indication signal is downlink control information (DCI) or radio resource control (RRC) signaling; the carrier indication information is RRC signaling; the terminal group is determined according to a type and/or a state of the terminal device; the at least one indication information is configured to instruct at least one terminal group to use at least two PDSCH time-frequency resource blocks.

In an embodiment, the state of the terminal device includes an idle state and/or an inactive state; and/or
the type of the terminal device comprises at least one of the following: a mobile terminal, an Internet of Things terminal, a reduce capability terminal, and an industrial Internet of Things terminal.

In an embodiment, the indication information includes terminal group indication information and/or PDSCH time-frequency resource block information.

In an embodiment, the PDSCH time-frequency resource block information includes at least one of the following:
resource configuration information in a frequency domain;
resource configuration information in a time domain;
resource offset indication information in the frequency domain;
resource offset indication information in the time domain;
an index of the resource block.

In an embodiment, the indication information is determined by at least one of the following ways:
determining the resource configuration information in the frequency domain according to the position of the PDSCH time-frequency resource block;
determining the resource configuration information in the time domain according to the position of the PDSCH time-frequency resource block;
determining the resource offset indication information in the frequency domain according to the position of the PDSCH time-frequency resource block;
determining the resource offset indication information in the time domain according to the position of the PDSCH time-frequency resource block;
determining the index of the resource block according to the position of the PDSCH time-frequency resource block.

In an embodiment, the resource offset indication information is configured to indicate a resource offset of any group relative to a reference group; the resource configuration information in the frequency domain includes a sequence number of a subcarrier and/or a number of subcarriers; the resource configuration information in the time domain includes a sequence number of a symbol and/or a number of symbols.

The device provided in this embodiment can be used to execute the technical solution of the embodiment shown in FIG. 16, and its implementation principle and technical effect are similar, and details will not be repeated here in this embodiment.

FIG. 21 is a schematic structural diagram of a communication device according to an embodiment of the present application. The communication device described in this embodiment may be the terminal device (or a component applicable to a terminal device) or a network device (or a component applicable to a network device) mentioned in the foregoing method embodiments. The communication device may be used to implement the method corresponding to the terminal device or the network device described in the above method embodiment, for details, refer to the description in the above method embodiment.

As shown in FIG. 21, the communication device in this embodiment includes a processor 2101 and a memory 2102. The memory 2102 is configured to store computer-executable instructions, and when the computer-executable instructions are executed by the processor 2101, the information processing method in any of the foregoing embodiments is implemented. For details, refer to the related descriptions in the foregoing method embodiments.

In an embodiment, the memory 2102 can be independent or integrated with the processor 2101.

For the functions and effects of the communication device provided in the embodiments of the present application, reference may be made to the foregoing embodiments, and details are not repeated here.

The embodiment of the present application also provides a computer-readable storage medium, where computer-executable instructions are stored in the computer-readable storage medium, and when a processor executes the computer-executable instructions, the above-mentioned information processing method is implemented.

The embodiment of the present application also provides a computer program product, where the computer program product includes computer program code, and when the computer program code is run on a computer, the computer is made to execute the methods described in the various possible implementation manners above.

The embodiment of the present application also provides a chip, including a memory and a processor. The memory is configured to store a computer program, and the processor is configured to call and run the computer program from the memory, so that the communication device installed with the chip executes the methods described in the various possible implementation manners above.

In the several embodiments provided in the present application, it should be understood that the disclosed devices and methods may be implemented in other ways. For example, the device embodiments described above are only illustrative. For example, the division of the modules is only a logical function division, and there may be other division methods during actual implementation. For example, modules may be combined or integrated into another system, or some features may be omitted, or not implemented. In another point, the mutual coupling or direct coupling or communication connection shown or discussed may be through some interfaces, and the indirect coupling or communication connection of devices or modules may be in electrical, mechanical or other forms.

The above-mentioned integrated modules implemented in the form of software function modules can be stored in a computer-readable storage medium. The above-mentioned software function modules are stored in a storage medium, and include several instructions to make a computer device (which may be a personal computer, server, or network device, etc.) or a processor execute some steps of the methods described in various embodiments of the present application.

It should be understood that the above-mentioned processor may be a central processing unit (CPU), and may also be other general-purpose processors, a digital signal processor (DSP), an application specific integrated circuit (ASIC) and the like. A general-purpose processor may be a microprocessor, or the processor may be any conventional processor, or the like. The steps of the method disclosed in conjunction with the present application can be directly implemented by a hardware processor, or implemented by a combination of hardware and software modules in the processor.

The memory may include a high-speed random access memory (RAM), and may also include a non-volatile memory (NVM), such as at least one disk memory, and may also be a U disk, a mobile hard disk, a read-only memory, a magnetic disk, or an optical disk.

The bus may be an industry standard architecture (ISA) bus, a peripheral component interconnection (PCI) bus, or an Extended Industry Standard Architecture (EISA) bus or the like. The bus can be divided into address bus, data bus, control bus and so on. For ease of representation, the buses in the drawings of the present application are not limited to only one bus or one type of bus.

The above-mentioned storage medium may be realized by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk. A storage media may be any available media that can be accessed by a general purpose or special purpose computer.

In the above-mentioned embodiments, the descriptions of each embodiment have their own emphases, and for parts that are not detailed or recorded in a certain embodiment, refer to the relevant descriptions of other embodiments.

Through the description of the above embodiments, those skilled in the art can clearly understand that the methods of the above embodiments can be implemented by means of software plus a necessary general-purpose hardware platform, and of course also by hardware, but in many cases the former is better implementation. Based on this understanding, the essence of the technical solution of the present application or the part that contributes to the prior art can be embodied in the form of software products, the computer software product is stored in one of the above storage media (such as ROM/RAM, magnetic disk, optical disk), including several instructions to make a terminal device (which may be a mobile phone, a computer, a server, a controlled terminal, or a network device, etc.) execute the method of each embodiment of the present application.

The above are only some embodiments of the present application, and are not therefore limiting the scope of the present application. Any equivalent structure or equivalent process transformation made by using the contents of the specification and drawings of the present application, or directly or indirectly used in other related technical fields, is also included in the scope of the present application.

What is claimed is:

1. An information processing method, applied to a terminal device, comprising:
receiving a paging indication signal, wherein the paging indication signal comprises at least one indication information, and the indication information is configured to indicate at least one physical downlink share channel (PDSCH) time-frequency resource block that provides a paging message of a terminal group; and
receiving the paging message in the corresponding PDSCH time-frequency resource block according to the indication information.

2. The method according to claim 1, wherein receiving the paging message in the corresponding PDSCH time-frequency resource block according to the indication information comprises:
determining a position of the PDSCH time-frequency resource block according to the indication information; and
receiving the paging message through the resource block corresponding to the position.

3. The method according to claim 1, wherein at least one of the following is comprised:
the paging indication signal is downlink control information (DCI) or radio resource control (RRC) signaling;
the terminal group to which it belongs is determined according to a type and/or a state of the terminal device; and
the at least one indication information is configured to instruct at least one terminal group to use at least two PDSCH time-frequency resource blocks.

4. The method according to claim 3, wherein:
the state of the terminal device comprises an idle state and/or an inactive state; and/or
the type of the terminal device comprises at least one of the following: a mobile terminal, an Internet of Things terminal, a reduce capability terminal, and an industrial Internet of Things terminal.

5. The method according to claim 1, wherein the indication information comprises terminal group indication information and/or PDSCH time-frequency resource block information.

6. The method according to claim 5, wherein the PDSCH time-frequency resource block information comprises at least one of the following:
resource configuration information in a frequency domain;
resource configuration information in a time domain;
resource offset indication information in the frequency domain;
resource offset indication information in the time domain; and
an index of the resource block.

7. The method according to claim 6, wherein the position of the PDSCH time-frequency resource block is determined by at least one of the following ways:
determining the position of the PDSCH time-frequency resource block according to the resource configuration information in the frequency domain;
determining the position of the PDSCH time-frequency resource block according to the resource configuration information in the time domain;
determining the position of the PDSCH time-frequency resource block according to the resource offset indication information in the frequency domain;
determining the position of the PDSCH time-frequency resource block according to the resource offset indication information in the time domain; and
determining the position of the PDSCH time-frequency resource block according to the index of the resource block.

8. The method according to claim 6, wherein at least one of the following is comprised:
the resource offset indication information is configured to indicate a resource offset of any group relative to a reference group;
the resource configuration information in the frequency domain comprises a sequence number of a subcarrier and/or a number of subcarriers; and
the resource configuration information in the time domain comprises a sequence number of a symbol and/or a number of symbols.

9. An information processing method, applied to a network device, comprising:
determining at least one indication information, wherein the indication information is configured to indicate at least one physical downlink share channel (PDSCH) time-frequency resource block that provides a paging message of a terminal group; and
sending a paging indication signal, wherein the paging indication signal comprises the at least one indication information.

10. The method according to claim 9, further comprising:
determining a position of at least one PDSCH time-frequency resource block for providing the paging message of the terminal group; and
generating the indication information according to the position of the PDSCH time-frequency resource block.

11. The method according to claim 9, wherein at least one of the following is comprised:
the paging indication signal is downlink control information (DCI) or radio resource control (RRC) signaling;
the terminal group is determined by a type and/or a state of the terminal device; and
the at least one indication information is configured to instruct at least one terminal group to use at least two PDSCH time-frequency resource blocks.

12. The method according to claim 11, wherein:
the state of the terminal device comprises an idle state and/or an inactive state; and/or
the type of the terminal device comprises at least one of the following: a mobile terminal, an Internet of Things terminal, a reduce capability terminal, and an industrial Internet of Things terminal.

13. The method according to claim 9, wherein the indication information comprises terminal group indication information and/or PDSCH time-frequency resource block information.

14. The method according to claim 13, wherein the PDSCH time-frequency resource block information comprises at least one of the following:
resource configuration information in a frequency domain;
resource configuration information in a time domain;
resource offset indication information in the frequency domain;
resource offset indication information in the time domain; and
an index of the resource block.

15. The method according to claim 14, wherein the indication information is determined by at least one of the following ways:
determining the resource configuration information in the frequency domain according to a position of the PDSCH time-frequency resource block;
determining the resource configuration information in the time domain according to the position of the PDSCH time-frequency resource block;
determining the resource offset indication information in the frequency domain according to the position of the PDSCH time-frequency resource block;
determining the resource offset indication information in the time domain according to the position of the PDSCH time-frequency resource block; and
determining the index of the resource block according to the position of the PDSCH time-frequency resource block.

16. The method according to claim 14, wherein at least one of the following is comprised:
the resource offset indication information is configured to indicate a resource offset of any group relative to a reference group;
the resource configuration information in the frequency domain comprises a sequence number of a subcarrier and/or a number of subcarriers; and
the resource configuration information in the time domain comprises a sequence number of a symbol and/or a number of symbols.

17. A communication device, comprising:
a processor; and
a memory,
wherein the memory stores computer-executable instructions, and when the computer-executable instructions are executed by the processor, the information processing method according to claim 1 is implemented.

18. A non-transitory computer readable storage medium, wherein the non-transitory computer-readable storage medium stores computer-executable instructions, and when the computer-executable instructions are executed by a processor, the information processing method according to claim 1 is implemented.
